(19) United States
(12) Patent Application Publication
(10) Pub. No.: US 2012/0278188 A1
(43) Pub. Date: Nov. 1, 2012

(54) CARRYING OUT AN ALTERNATIVE PAYMENT VIA A USER EQUIPMENT OVER A WIRELESS NETWORK AT A POINT OF SALE WITHOUT ALTERING THE POINT OF SALE

(75) Inventors: Tsafrir ATTAR, Ganey Tikva (IL); Yosef YARKONI, Ramat Hasharon (IL)

(73) Assignee: DIGIMO LTD., Hod Hasharon (IL)

(21) Appl. No.: 13/096,554

(22) Filed: Apr. 28, 2011

(51) Int. Cl. G06Q 20/00; G06Q 40/00

(52) U.S. Cl. 705/17; 235/379

(57) ABSTRACT

A system for carrying out an alternative payment via user equipment (UE) over a wireless network at a point of sale (POS) without altering the POS is provided herein. The system includes a third party server and a plurality of preregistered UEs. Each UE is configured to: receive a visual identifier associated with a magnetic card at the POS and transmit to the server a unique identifier of the POS/card and the unique identifier of the customer. The server is configured to: obtain financial details regarding the primary transaction generated by the POS, receive the unique identifier of the POS and the unique identifier of the customer from the UE, approve the primary transaction if financial settlement means associated with the customer are sufficient, and establish a secondary financial transaction between the customer and the third party, for settling the debt of the customer to the third party.

### BACKGROUND

1. Technical Field

The present invention relates to alternative payment methods and more particularly, to settling a bill via user equipment over a wireless network at a point of sale.

2. Discussion of the Related Art

In recent years, payment via cellular phone (also known as mobile payment) becomes ever more popular. Statistically, most transactions via mobile phones are used for the purchase of virtual goods. These include mobile content such as ringtones, parking, mobile games and the like, in which billing is carried out using the billing systems of the mobile operator or credit cards and the payment means used for the transaction is the one used by the customer to pay for his mobile bill—either prepaid or postpaid.

Alternatively, in exiting technology, the customer can also use a wireless (Internet or other) connection to purchase physical goods, over retailers websites. By doing so, the customer usually needs to input or select his preferred payment mean for the transaction, which can by credit/debit card details. The customer can also choose to pay using other clearing finance clearing account or similar. These use pre-registered payment means.

Another manner to carry out transaction over mobile phone is at a retailer shop, upon payment at the POS. A necessary condition for enabling such a transaction at a physical point of sale is the communication between the mobile phone and the point of sale. Some technologies are configured and known to be used for this purpose such as near field communication (NFC), radio frequency identification (RFID), Barcode, Bluetooth, and the like. However, all of these methods involve addition or replacement of hardware equipment at the point of sale (Bluetooth, NFC/RFID) or make software adjustments at the Point of Sale (Barcode). Some solutions even require changing or adding certain components to the mobile handset. These changes are associated with huge financial investments and long implementation processes.

### BRIEF SUMMARY

One aspect of the present invention provides a system for carrying out a settling a bill via preregistered user equipment (UE) such as a mobile phone, over a wireless network at a point of sale (POS), without altering the POS. The system includes: a UE configured to communicate over at least one wireless network and further associated with a unique identifier of a customer; a POS associated with a retailer; a magnetic card associated with a visual identifier and configured to initiate a primary financial transaction at the POS and associated with a third party other than the retailer and the customer, wherein the primary financial transaction is between the third party and the retailer.

The system further includes a server associated with the third party configured to communicate both with the POS and with the UE, wherein the UE is configured to: (i) receive the visual identifier entered by the customer and (ii) transmit to the server, over the wireless network: (a) a unique identifier of the POS/card, based on the received visual identifier and (b) the unique identifier of the customer, wherein the server is configured to : (i) obtain financial details regarding the primary transaction, generated by the POS, (ii) receive the unique identifier of the POS and the unique identifier of the customer from the UE, (iii) approve the primary transaction if financial settlement means associated with the customer are sufficient in view of the financial details regarding the primary transaction, and (iv) establish a secondary financial transaction between the customer and the third party such that the secondary financial transaction settles a debt of the customer to the third party due to the primary financial transaction.

Another aspect of the present invention provides a method of carrying out a settling a bill (e.g. paying) via a user equipment (UE) over a wireless network at a point of sale (POS) associated with a retailer, the method may include the following steps: transmitting over at least one wireless network a request for wireless payment carrying a unique identifier of a customer; initiating, responsive to applying a card reader to a magnetic card associated with a visual identifier, a primary financial transaction at the POS and associated with a third party other than the retailer and the customer, wherein the primary financial transaction is between the third party and the retailer; transmitting from the UE to the server of the third party: (i) an identifier of the POS, derived based on the visual identifier entered to the UE by the customer, and (ii) the unique identifier of the customer; obtaining, by the server of the third party, financial details regarding the primary transaction, generated by the POS; receiving, at the server of the third party, the unique identifier of the POS and the unique identifier of the customer from the UE; approving the primary transaction if financial settlement means associated with the customer are sufficient in view of the financial details regarding the primary transaction, and establishing a secondary financial transaction between the customer and the third party, such that the secondary financial transaction settles a debt of the customer to the third party due to the primary financial transaction.

Other aspects of the invention may include a computer readable program configured to execute the aforementioned system. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating a possible environment of a system according to some embodiments of the invention; and

FIG. 2 is a high level flowchart diagram illustrating a method according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “user equipment” or simply “UE” as used herein in this application refers to any device that is equipped with wireless communication capabilities. Possibly, but not exclusively mobile phones. Other UE may include a personal device accessory, a personal computer, a Tablet PC. These UE may be either application specific or general purpose and may have other primary functionalities or dedicated only for carrying out embodiments of the present invention.

The term “point of sale” or “POS” as used herein in this application refers to any combination of hardware and software modules that are configured to initiate and process a payment transaction usually via a magnetic card reader and a other input modules configured to generate details of a sale including products or services bought, terms of payment and the like. A POS is associated with a specific retailer and is in communication with one or more financial intuitions or other remote servers that are configured to approve or decline a request for authorization of a transaction.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

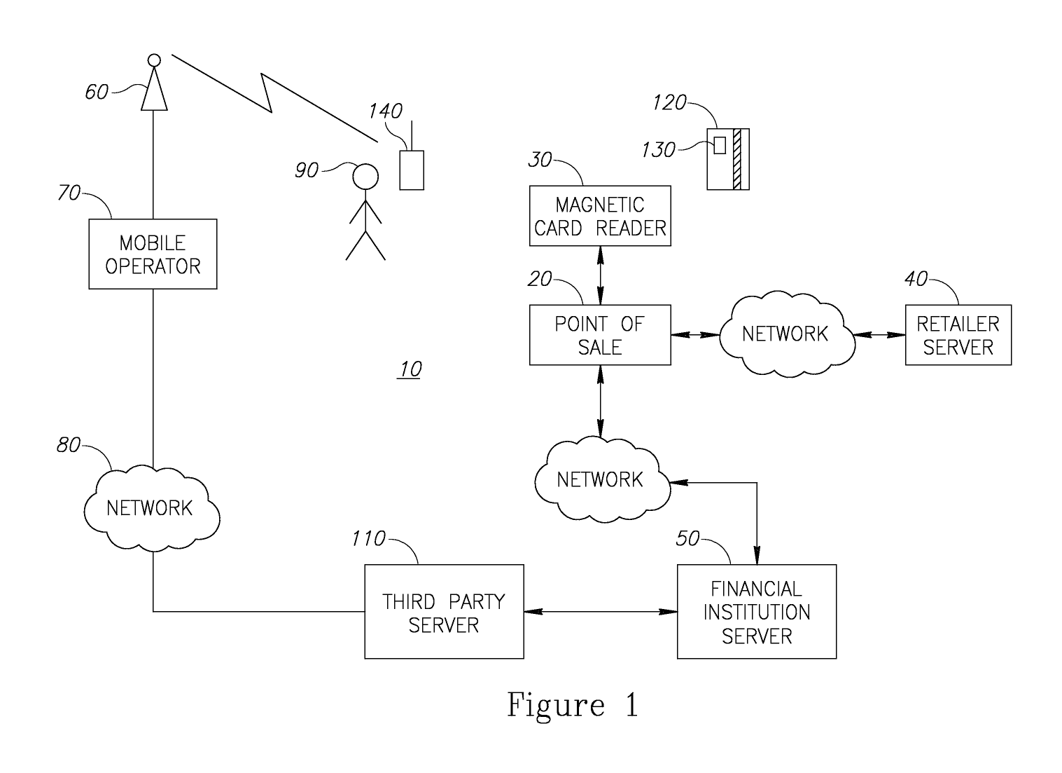

FIG. 1 is a high level schematic block diagram illustrating a possible system located in an environment in accordance with some embodiments of the present invention. Environment 10 depicts a system for carrying out a payment via pre-registered UE 140 over a wireless network 80 at a POS. The system includes: a UE 140 of a customer 90 configured to communicate over at least one wireless network 80 possibly of a mobile operator 70 via a base station 60 or a Wi-Fi network (not shown). Each one of the UEs is further associated with a unique identifier of the customer usually due to a pre-registration process in which the customer registers himself or herself and further provide financial settlement means as will be explained in details below.

The system further includes an existing non-altered POS 20 associated with a specific retailer, possibly in communication with a retailer server 40. POS 20 is associated with a dedicated magnetic card 130 that is associated with a visual identifier 130. Magnetic card 120 is configured to initiate a primary financial transaction at the POS via its integral magnetic card reader 30 and is further associated with a third party other than the retailer and the customer, wherein the primary financial transaction is between the third party and the retailer. It should be noted that the primary financial transaction is based on the worldwide standard financial flow with the necessary changes in accordance with embodiments of the present invention. As will be shown below, embodiments of the present invention enable retrofitting the alternative method of settling a bill of the present invention into existing POS terminals without the need to alter POS terminals.

Magnetic card 120 is situated in the vicinity of POS 20 at all times readily available for the cashier (not shown) for using upon any request of customer 90 who is equipped with preregistered UE 140. Visual identifier 130 may be in a form of a sticker attached to magnetic card 120 or any sign attached at the vicinity of POS 20. The visual identifier is located such that customer 90 may see it while being near POS 20 and while conducting a payment. The magnetic card may be a credit card, debit card, or prepaid card issued by a financial institution to the third party.

The system further includes a third party server 110 associated with the third party configured to communicate both with POS 20 and with the preregistered UE 140. Preregistered UE 140 is configured to: (i) receive visual identifier 130 entered by the customer or alternatively to capture it via a camera and (ii) transmit to the third party server 110, over the wireless network 80: (a) a unique identifier of POS/card 20, based on the received visual identifier 130 and (b) the unique identifier of customer 90.

Third party server 110 is configured to: (i) obtain financial details regarding the primary transaction, generated by POS 20, (ii) receive the unique identifier of POS 20 and the unique identifier of customer 90 from the UE, (iii) approve the primary transaction if financial settlement means associated with customer 90 are sufficient in view of the financial details regarding the primary transaction, and (iv) establish a secondary financial transaction between customer 90 and the third party such that the secondary financial transaction settles a debt of the customer to the third party due to the primary financial transaction.

Specifically, third party server 110 and generally the system in accordance with embodiments of the present invention required only an authorization from POS 20 to be provided with the financial details of the primary transaction but no altering or addition to any of the software or hardware modules of POS 20 are required. In other words, embodiments of the present invention may be easily retrofitted into existing POS 20 terminal without any integration or additions to the graphical user interface of input-output modules.

Consistent with some embodiments of the present invention, the third party and the retailer are the same. In this private case, a retailer may offer an easy manner of payment for its customers and the primary and secondary transactions are settled between the retailer and the customer based on the financial settlement means.

Consistent with some embodiments of the present invention, preregistered UE 140 may, by using a built-in camera and a dedicated application, capture the visual identifier and derive a respective unique card/POS identifier associated with the visual identifier. This visual identifier may be in a form of a 2D barcode. Alternatively, the customer may have to enter manually the visual identifier, be it numbers or character or the like. UE 140 may be a dedicated device that can communicate over a local wireless network such as RFID or NFC with a relay (not shown) for later conveying the unique identifier of the customer 90 and the unique identifier of card/POS 20 to third party server 110.

Consistent with some embodiments of the present invention, UE 140 may be configured to use a specified mapping or a table to convert visual identifier 120 into the unique identifier of customer 90. Specifically, unique identifier of customer 90 may be, for example, a password or a MAC address of UE 140.

Consistent with some embodiments of the present invention, the primary financial transaction is processed by a financial institution server configured to request an approval for the primary financial transaction from the server of the third party. Upon such a request, the third party server checks if the respective customer has sufficient funds with his or her financial settlement means.

Consistent with some embodiments of the present invention, the financial settlement means are established during a pre-registration process between the customer and the server of the third party such that the financial settlement means enables the server of the third party to establish future secondary financial transaction devised to settle debts due to a respective primary financial transaction. Such a preregistration process is very similar to common preregistration processes in which a customer provides details that include means or measure for settling bills beforehand (i.e., before an actual transaction occurred).

Consistent with some embodiments of the present invention, the financial details regarding the primary transaction are further based on redemption of a coupon or a voucher (not shown) at POS 20 and wherein details on the redemption are transmitted by UE 140 to of third party server 110 so that the secondary financial transaction takes into account the redemption. In a typical scenario for this embodiment, a customer provides, at POS 20, a voucher or a coupon—either in paper or over his or her UE 140. The cashier enters the details of the voucher or the coupon into POS 20. These details are checked and confirmed at the third party server and/or the retailer. If correct, the primary transaction is approved and the secondary transaction further reflects the redemption.

Consistent with some embodiments of the present invention, the financial settlement means may include a form of pre-payment or any other assurance that is financial viable. Some of the pre-payment method may refer to a loyalty scheme when payment substitute such as accumulated point may be used. Some non-limiting examples for financial settlement means may include: credit card authorization, debit card authorization, bank transfer authorization, points associated with loyalty card, and a prepaid account.

Consistent with some embodiments of the present invention, the customer is approved as an ad hoc beneficiary of the third party, for the primary financial transaction responsive to a request transmitted by UE 140 to the server 110 of the third party. Optionally and alternatively, the customer is approved as a beneficiary of the third party, for future primary financial transactions responsive to a request of the customer at a pre-registration process. Advantageously, the approval of a customer as a beneficiary of the third party will reduce handling costs for the primary financial transaction making embodiments of the present invention more financially viable for retails to adopt.

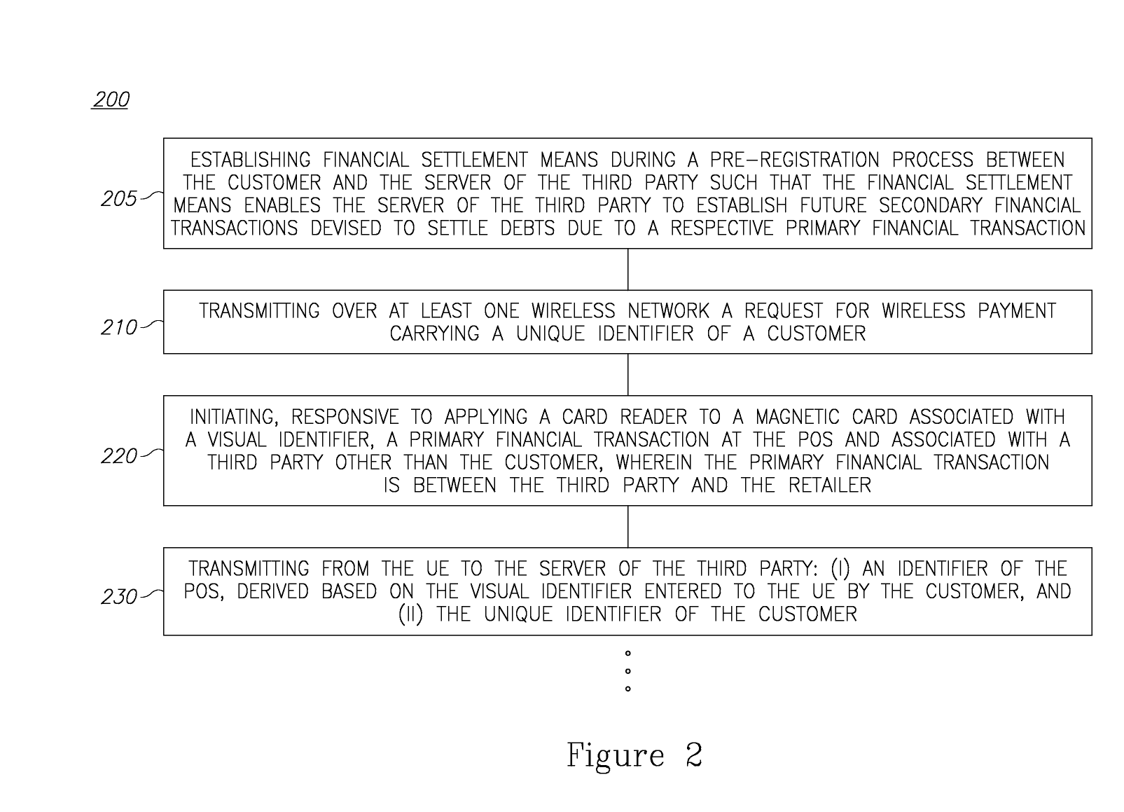

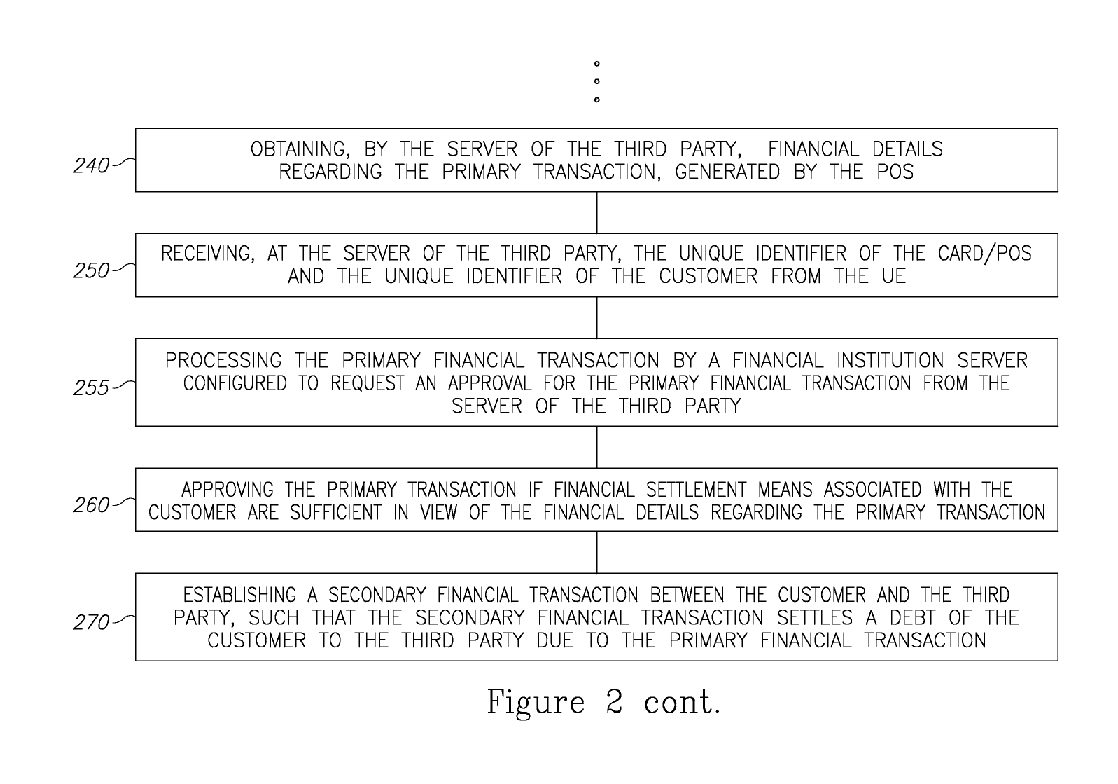

FIG. 2 is a high level flowchart diagram illustrating a method 200 according to some embodiments of the invention. Method 200 is provides the ability to carry out a payment via a UE over a wireless network at a point of sale associated with a retailer without altering the POS. Method 200 starts with the first phase that includes the following steps: transmitting over at least one wireless network a request for wireless payment carrying a unique identifier of a customer 210; initiating, responsive to applying a card reader to a magnetic card associated with a visual identifier, a primary financial transaction at the POS and associated with a third party other than the retailer and the customer, wherein the primary financial transaction is between the third party and the retailer 220.

Method 200 then goes on to the second phase that includes the following steps: transmitting from the UE to the server of the third party: (i) an identifier of the POS, derived based on the visual identifier entered to the UE by the customer, and (ii) the unique identifier of the customer 230; obtaining, by the server of the third party, financial details regarding the primary transaction, generated by the POS 240; receiving, at the server of the third party, the unique identifier of the POS and the unique identifier of the customer from the UE 250.

Finally, method 200 goes on to the third phase that includes the following steps: approving the primary transaction if financial settlement means associated with the customer are sufficient in view of the financial details regarding the primary transaction 260, and establishing a secondary financial transaction between the customer and the third party, such that the secondary financial transaction settles a debt of the customer to the third party due to the primary financial transaction 270.

Consistent with some embodiments of the present invention, method 200 may further include the step of processing the primary financial transaction by a financial institution server configured to request an approval for the primary financial transaction from the server of the third party 255.

Consistent with some embodiments of the present invention, method 200 may further include the step of establishing financial settlement means during a pre-registration process between the customer and the server of the third party such that the financial settlement means enables the server of the third party to establish future secondary financial transactions devised to settle debts due to a respective primary financial transaction 205.

Consistent with some embodiments of the present invention, the financial details regarding the primary transaction are further based on redemption of vouchers or coupons at the POS and wherein details on the redemption are transmitted by the UE to the server of the third party so that the secondary financial transaction takes into account the redemption.

Consistent with some embodiments of the present invention, method 200 may further include the step of approving a customer as an ad hoc beneficiary of the third party, for the primary financial transaction responsive to a request transmitted by the UE to the server of the third party. The approval may be carried out for future primary financial transactions responsive to a request of the customer at a pre-registration process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for settling a bill via a user equipment (UE) over a wireless network at a point of sale (POS), without altering the POS, the system comprising:
a UE configured to communicate over at least one wireless network and further associated with a unique identifier of a customer;
a POS associated with a retailer;
a magnetic card associated with a visual identifier and configured to initiate a primary financial transaction at the POS, wherein the magnetic card is further associated with a third party other than the customer, wherein the primary financial transaction is between the third party and the retailer; and
a remote third party server associated with the third party and configured to communicate both with the POS and with the UE,
wherein the UE is configured to: (i) receive the visual identifier entered by the customer and (ii) transmit to the third party server, over the wireless network: (a) a POS unique identifier of the POS, based on the received visual identifier and (b) the unique identifier of the customer,
wherein the third party server is configured to: (i) obtain financial details regarding the primary transaction, generated by the POS, (ii) receive the unique identifier of the POS and the unique identifier of the customer from the UE, (iii) approve the primary transaction if financial settlement means associated with the customer are sufficient in view of the financial details regarding the primary transaction, and (iv) establish a secondary financial transaction between the customer and the third party such that the secondary financial transaction settles a debt of the customer to the third party due to the primary financial transaction.

2. The system according to claim 1, wherein the primary financial transaction is processed by a financial institution server configured to request approval for the primary financial transaction from the server of the third party.

3. The system according to claim 1, wherein the financial settlement means are established during a pre-registration process between the customer and the server of the third party such that the financial settlement means enables the server of the third party to establish future secondary financial transaction devised to settle debts due to a respective primary financial transaction.

4. The system according to claim 1, wherein the financial details regarding the primary transaction are further based on redemption of a coupon or a voucher at the POS and wherein details on the redemption are transmitted by the UE to the server of the third party so that the secondary financial transaction takes into account the redemption.

5. The system according to claim 1, wherein the financial settlement means comprises at least one of: credit card authorization, debit card authorization, bank transfer authorization, points associated with a loyalty scheme, and a prepaid account.

6. The system according to claim 1, wherein the customer is approved as an ad hoc beneficiary of the third party, for the primary financial transaction responsive to a request transmitted by the UE to the server of the third party.

7. The system according to claim 1, wherein the customer is approved as a beneficiary of the third party, for future primary financial transactions responsive to a request of the customer at a pre-registration process.

8. The system according to claim 1, wherein the visual identifier is a sticker attached to the magnetic card or attached to a vicinity of the POS.

9. The system according to claim 1, wherein the magnetic card is at least one of: a credit card, a debit card issued by a financial institution to the third party, a prepaid card, a dummy card operated by the retailer.

10. The system according to claim 1, wherein the UE comprises at least one of: a cellular communication device, a personal device accessory, a personal computer, a Tablet PC, and a device with wireless communication capabilities.

11. The system according to claim 1, wherein the third party is further other than the retailer.

12. The system according to claim 1, wherein the third party is the retailer and wherein the third party server is associated and controlled by the retailer.

13. The system according to claim 4, wherein the redemption and the primary transaction are carried out simultaneously.

14. A method of settling a bill via a user equipment (UE) over a wireless network at a point of sale (POS) associated with a retailer, the method comprising:
transmitting over at least one wireless network a request for wireless payment carrying a unique identifier of a customer;
initiating, responsive to applying a card reader to a magnetic card associated with a visual identifier, a primary financial transaction at the POS and associated with a third party other than the customer, wherein the primary financial transaction is between the third party and the retailer;
transmitting from the UE to the server of the third party: (i) an identifier of the POS, derived based on the visual identifier entered to the UE by the customer, and (ii) the unique identifier of the customer;
obtaining, by the server of the third party, financial details regarding the primary transaction, generated by the POS;
receiving, at the server of the third party, the unique identifier of the POS and the unique identifier of the customer from the UE;
approving the primary transaction if financial settlement means associated with the customer are sufficient in view of the financial details regarding the primary transaction; and
establishing a secondary financial transaction between the customer and the third party, such that the secondary financial transaction settles a debt of the customer to the third party due to the primary financial transaction.

15. The method according to claim 14, further comprising processing the primary financial transaction by a financial institution server configured to request an approval for the primary financial transaction from the server of the third party.

16. The method according to claim 14, further comprising establishing financial settlement means during a pre-registration process between the customer and the server of the third party such that the financial settlement means enables the server of the third party to establish future secondary financial transactions devised to settle debts due to a respective primary financial transaction.

17. The method according to claim 14, wherein the financial details regarding the primary transaction are further based on redemption of vouchers or coupons at the POS and wherein details on the redemption are transmitted by the UE to the server of the third party so that the secondary financial transaction takes into account the redemption.

18. The method according to claim 14, wherein the financial settlement means comprises at least one of: credit card authorization, debit card authorization, bank transfer authorization, points of a loyalty card, and a prepaid account.

19. The method according to claim 14, wherein the customer is approved as an ad hoc beneficiary of the third party, for the primary financial transaction responsive to a request transmitted by the UE to the server of the third party.

20. The method according to claim 14, wherein the customer is approved as a beneficiary of the third party, for future primary financial transactions responsive to a request of the customer at a pre-registration process.
